(19) United States
(12) Patent Application Publication
(10) Pub. No.: US 2008/0184568 A1
(43) Pub. Date: Aug. 7, 2008

(54) Split Power Tool

(75) Inventors: Jason Gieske, Bowling Green, KY (US); Cherry Bochmann, Bay Village, OH (US); Erin Riddell, Bay Village, OH (US)

Correspondence Address: SUITER SWANTZ PC LLO, 14301 FNB PARKWAY, SUITE 220, OMAHA, NE, 68154, US

(73) Assignee: Desa IP, LLC, Miami, FL (US)

(21) Appl. No.: 11/756,214

(22) Filed: May 31, 2007

Related U.S. Application Data
(60) Provisional application No. 60/888,535, filed on Feb. 6, 2007.

(51) Int. Cl. B25F 5/02; B27B 17/00

(52) U.S. Cl. 30/383; 173/217

(57) ABSTRACT

A power tool can be split into two ends and a pole can be inserted between the two ends. Each end of the power tool has an electrical connector that maintains electrical communication between the two ends. When the ends are separated, the extension pole can be attached to each end and each end of the pole has electrical connectors so that the two ends stay in electrical communication even with the pole in place allowing the trigger and battery to maintain electrical connectivity with the motor and implement.

### CROSS-REFERENCE TO RELATED APPLICATIONS

This application under 35 USC § 119(e) claims priority to, and benefit from, U.S. Provisional Application Ser. No. 60/888,535, filed on Feb. 6, 2007, entitled “Split Power Tool,” which is currently pending naming the above individuals as joint inventors.

### STATEMENT REGARDING FEDERALLY SPONSORED RESEARCH OR DEVELOPMENT

Not applicable.

### BACKGROUND OF THE INVENTION

### Field of the Invention

The present invention relates to an extendable and reconfigurable power tool. More particularly, the invention relates to a power tool having two halves and an extension pole that can be inserted between the two halves to electrically connect them and make the power head end of the tool operable even though separated from the actuation end.

### BRIEF DESCRIPTION OF THE DRAWINGS

The aspects and advantages of the present invention will be better understood when the detailed description of the preferred embodiment is taken in conjunction with the accompanying drawings, in which:

FIG. 1 is a side view of an embodiment of the extendable power tool of the present invention with a pole attachment;

FIG. 1 a is a top perspective view of an embodiment of the extendable power tool of the present invention with the handle end detached from the power head end;

FIG. 2 is a side view of an embodiment of the extendable power tool of the present invention without the pole attachment;

FIG. 3 is a side view of an embodiment of the extendable power tool of the present invention without the pole attachment;

FIG. 4 is a side view of an embodiment of the power tool of the present invention without the pole attachment with the two halves separated;

FIG. 5 is a front view of the handle end the power tool of the present invention depicting the handle end aperture for receiving the motor;

FIG. 6 is a front perspective view of an embodiment of the power head end of the power tool of the present invention;

FIG. 7 is a side view of the extension pole for use with the extendable power tool of the present invention;

FIG. 8 is a perspective view of one embodiment of the extension pole of FIG. 7;

FIG. 9 is a side view of the power head, handle end and extension pole of the present invention;

FIG. 10 is a top perspective view of the latch mechanism of the extension pole of the present invention; and

FIG. 11 is a view of an embodiment of the latch mechanism of the present invention.

### DETAILED DESCRIPTION OF THE EMBODIMENTS

While this invention is capable of embodiments in many different forms, multiple embodiments are shown in the figures and will be herein described in detail. The present disclosure is to be considered an exemplification of the principles of the invention and is not intended to limit the broad aspects of the invention to the embodiments illustrated.

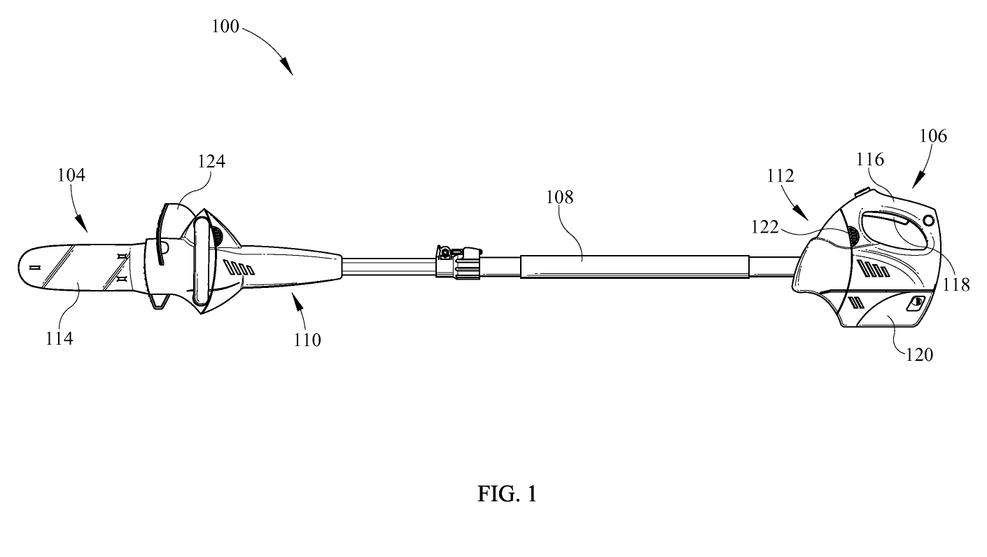

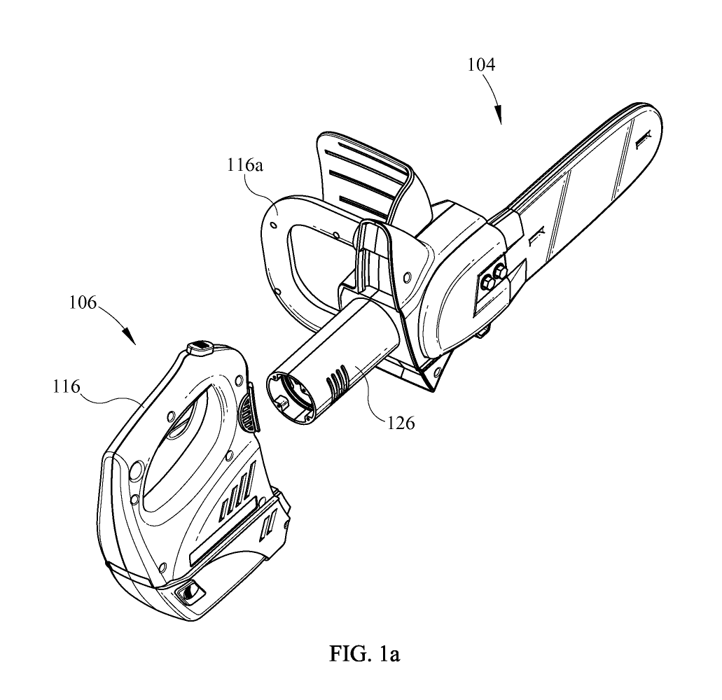

Turning now to the Figures and specifically to FIG. 1, an expandable power tool 100 comprises a housing 102 having a tool or power head end 104 and a handle end 106 separated by a power tool extension device or pole 108. In one embodiment, the pole 108 is a telescoping pole whose length is adjustable. The pole 108 shown in FIGS. 1 and 7-11 has a first end 110 that mechanically and electrically attaches to the power head end 104 of the power tool and a second end 112 that attaches to the handle or actuation end 106 of the tool. In the exemplary embodiment shown in FIG. 1, the tool or power head end 104 has a saw 114 attached, but other types of tools such as hedge trimmers, various power heads or other gardening implements can be used. The handle end 106 has a guard 116a as well as a handle 116 with a trigger 118 that is depressed in order to activate the power tool 100. In the embodiment depicted, the handle end 106 also has a battery 120, such as a NiCd 18V 1700 mah battery, which in FIG. 1 is positioned at the bottom of the handle end 106 but may be positioned in other areas. Of course, the battery or other power supply may alternatively be an AC line in from a power cord. In the exemplary extendable power tool embodiment 100 depicted in the figures, the chainsaw has a rear handle or rear portion 106, a hand guard 124 and a secondary handle 106a. There are, as depicted, two main sections, the main handle section 106 and the power head section 104. These two sections 104, 106 split apart via release buttons 122 on the handle section 106 allowing the power tool or implement to be separated into a working end and a trigger or other actuation. Typically the actuation or trigger end at the handle also contains the battery 120 in order to keep more weight to the rear section of the tool to make it more balanced and easily held during use in an extension mode. As can be seen, the extension pole 108 allows the two sections or ends to be in electrical and controlling contact but allows for the implement end of the tool to be extended significantly beyond the handle end thereby extending the reach of the tool. Various electrical contacts can be provided between handle end 106 and the implement or power head end 104 and also multiple configurations of the motor and the battery may be utilized, such as placement of either or both on the same end. Electrical or plug type contacts or connections may be utilized between the two halves with a male and female type receptacle utilized to maintain electrical connectivity between the battery, trigger and motor. Such electrically removable connection between the halves allows them to be separated readily while maintaining electrical control of the motor by the trigger. Further these same electrical contacts or plug type receptacles may be utilized in similarly positioned portions of the extension pole in order to readily allow the extension pole to be installed between the two halves of the tool. Further, wiring interior of the extension pole electrically connects the plugs or connectors at either end and also allows the pole to be collapsed or extended, as is known in the art.

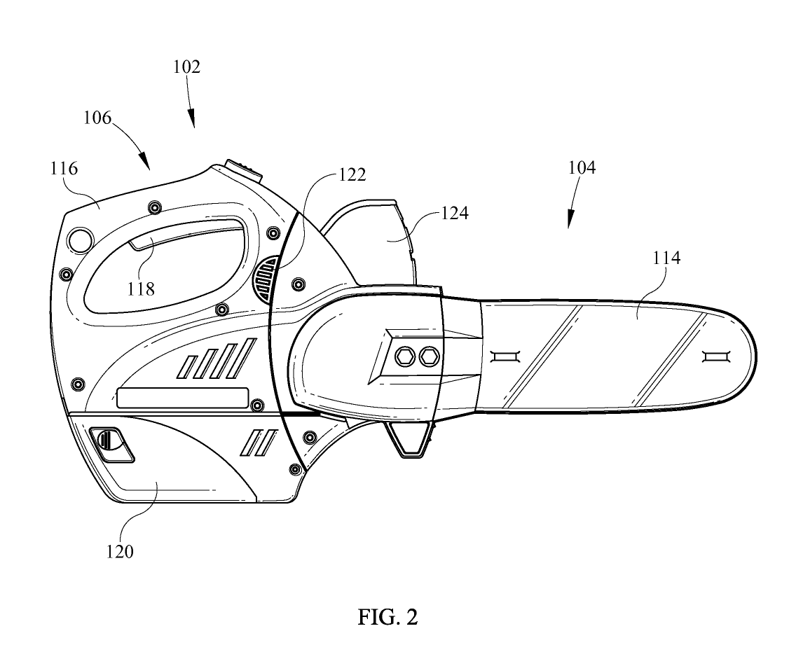

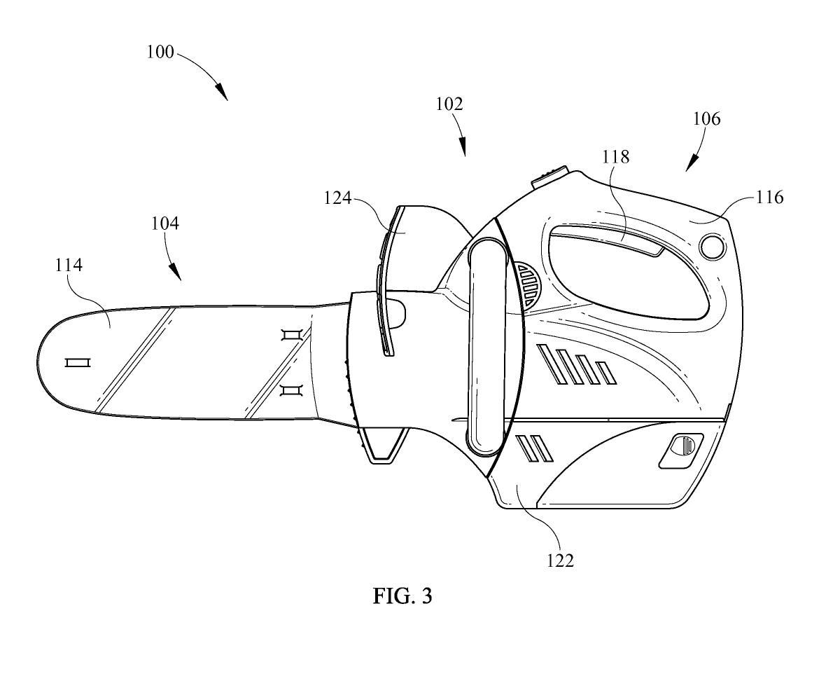

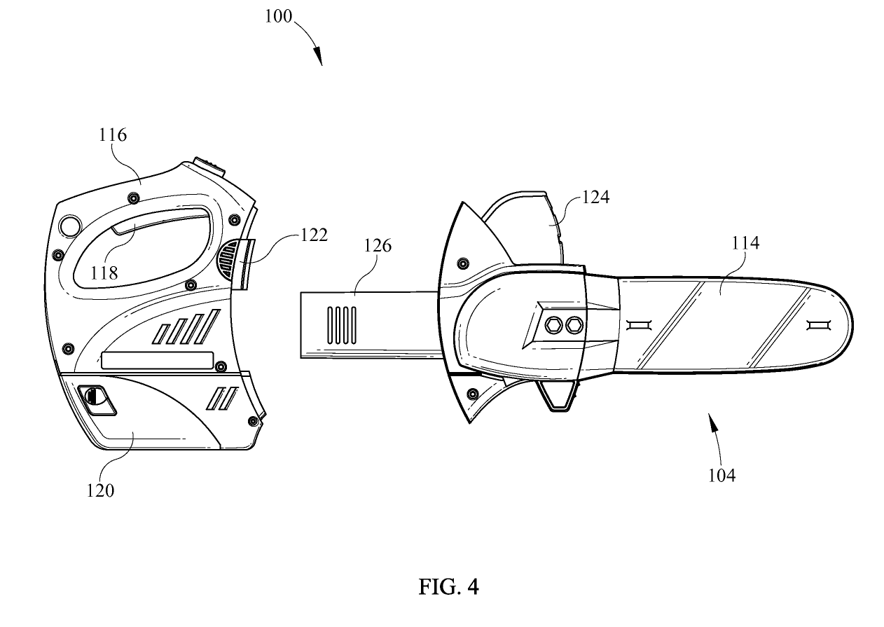

FIGS. 2 and 3 show an embodiment of the power tool 100 wherein the extension pole 108 has not been installed. In this configuration, the handle end 106 and the tool end 104 of the tool 102 are directly connected and not separated by a pole. As can be seen in FIGS. 2 and 3, the handle end 106 has a handle release button 122 on the side of the handle 116 that is adjacent the trigger 118. The handle release button 122 can be depressed in order to separate the two ends 104, 106 of the housing as shown in FIG. 4 so that a pole 108 can be inserted between them. The release button may be placed in alternative portions of the handle end or on the power tool end and may be biased in the connected or actuated position so as to maintain the two ends in mechanical as well as electrical contact.

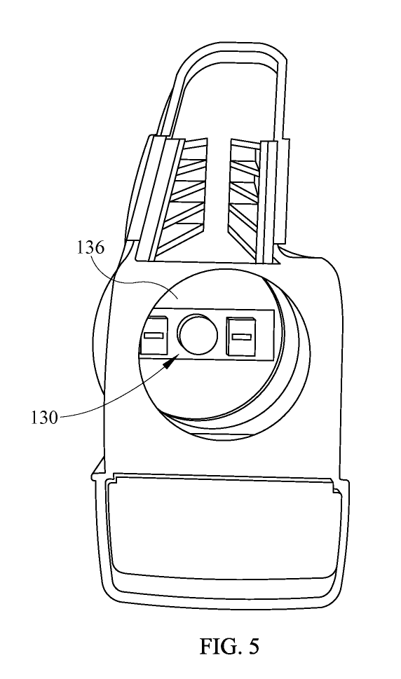

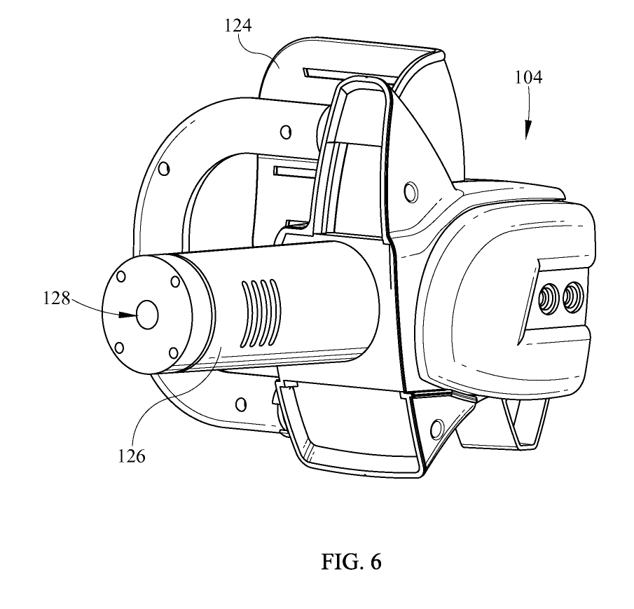

FIG. 4 shows a side view of the power tool 100 with the two ends separated and without an extension pole 108 attached therebetween. The tool end 104 has an electric motor 126 which may also act as a mounting extension which inserts into a handle recess 136 on the handle end 106. The motor or mounting extension 126 has a second electrical connector 128, shown in FIG. 6, that electrically and controllingly connects to a first connector 130 of the handle end 106, as shown in FIG. 5. The battery 120 of the handle end 106 connects to the first connector 130 by way of electrical wiring. The first connector 130 is in electrical contact with the second connector 128, and the second connector 128 is in electrical connection with the motor 126 of the tool end 104. Thus, electricity flows from the battery 120 to the motor, which powers the saw. The connectors 130 and 128 can be of any known electrical connection in order that the handle end trigger 118 can electrically control the motor and power tool implement a the opposite end of the tool or implement. The motor 126 may be a DC electric motor which is of acceptable size and power to actuate the implement end of the power tool. As shown the DC motor 126 may be integrated with the mounting extension or may be integrated directly within the housing of the implement end of the tool.

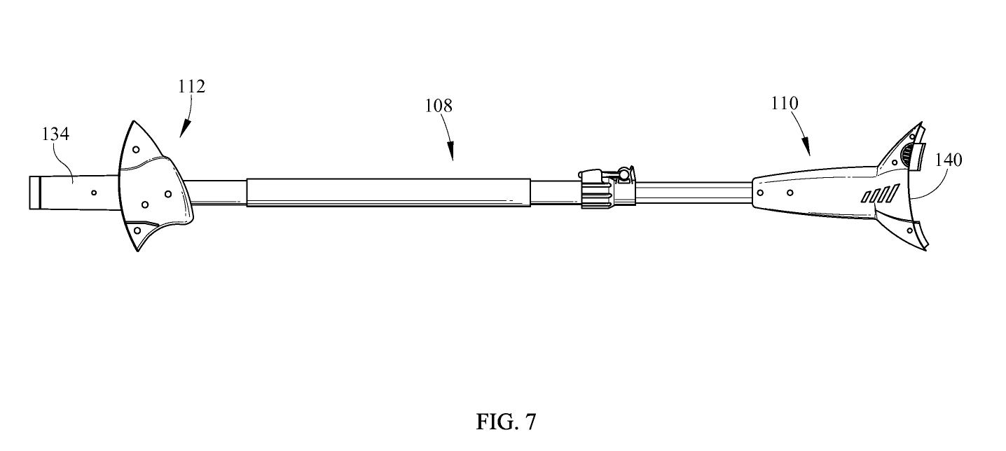

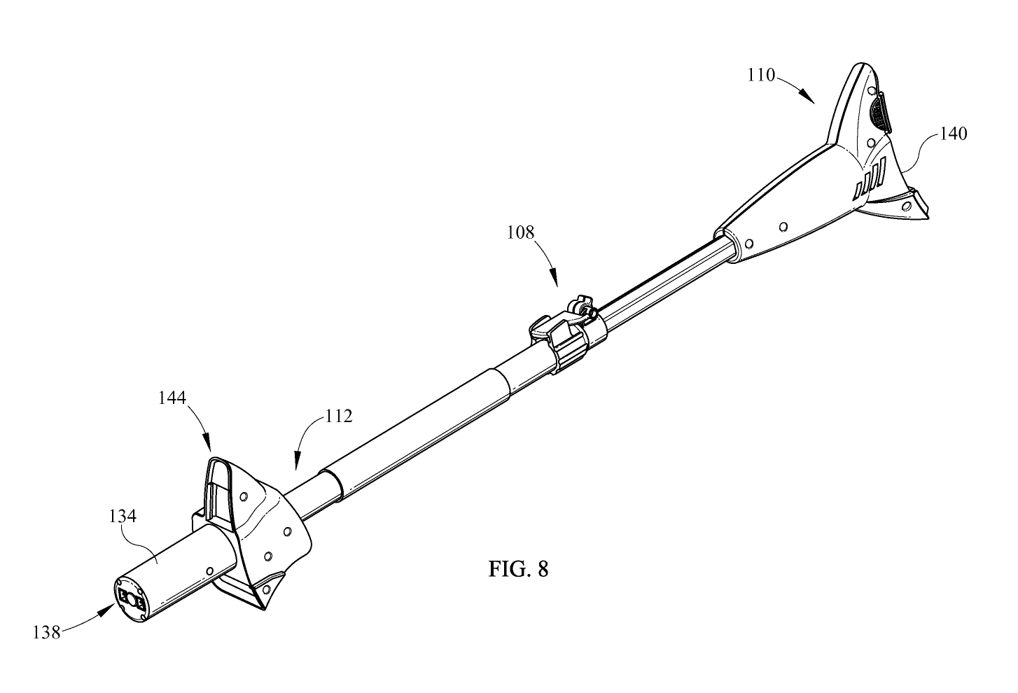

FIG. 7-11 shows a side view of the extension pole 108 which fits between the two separated sections of the power tool implement. The extension pole 108 has a first end 110 having a recess 140 and a second end 112 having an extension 134. As shown in FIG. 8, the extension 134 has a third connector 138 on its outer edge. The locking extension 134 of the pole 108 fits in the handle recess 136 and electrically connects to the first connector 130. At the first end 110 of the pole 108 is a pole recess 140, which has a fourth connector therein to which the second connector 128 of the mounting extension 126 electrically connects in order that the electrical connection between the trigger and the power head is maintained even with the extension pole in place. The pole 108 contains wiring interiorly it that electrically connects the third connector 138 to the fourth connector and thereby connects the battery 120 to the motor of the tool end 106.

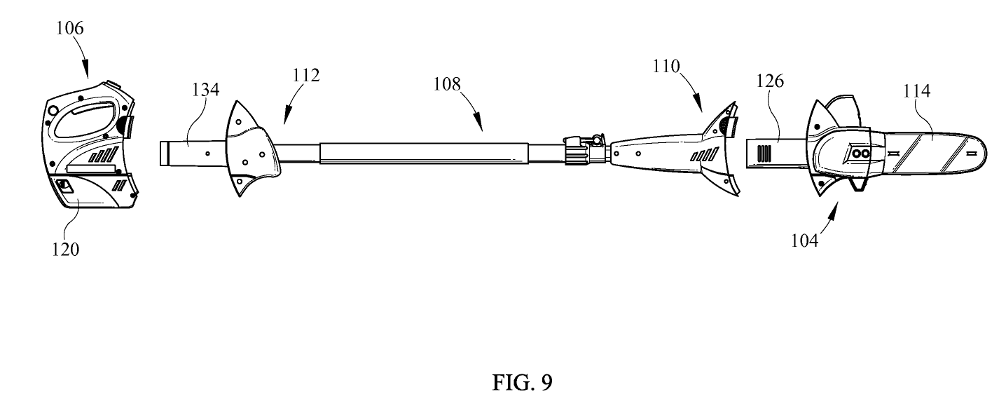

A separated view of an embodiment of the power tool 100 with a pole 108 is shown in FIG. 9. The housing 102 is shown split into its tool end 104 and handle end 106 and the pole 108 positioned there between. As can be seen in FIG. 9, the motor or mounting extension 126 of the tool end 104 is similar in construction to the locking extension 134 of the pole 108 such that they both fit into the handle recess 136. Likewise, the handle recess 136 and the pole recess 140 are similar such that the motor 126 fits into both. In the embodiment depicted, the pole 108 may be a telescoping pole and may have an adjustable length by use of a telescoping locking ring positioned thereon allowing the outer end of the extension pole to telescope into the end nearer the handle end of the tool or other implement. This configuration is depicted in the differences in length shown between FIGS. 7 and 9 wherein FIG. 7 shows a lengthened pole and FIG. 9 depicts a shortened pole with the locking ring all the way abutting the first end 110 of the pole 108.

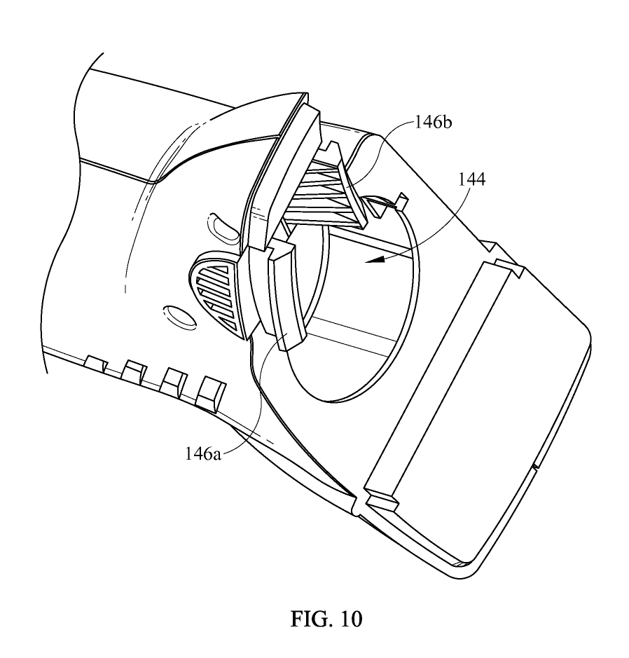

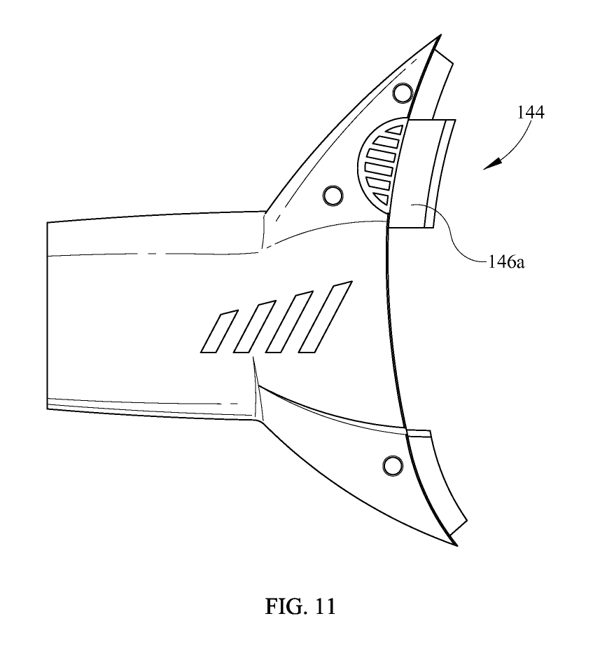

FIGS. 10 and 11 show the latching mechanism 144 of on embodiment of the invention. There may be two latch mechanisms 144 on the first end 110 of the extension pole, such latch mechanisms similar in construction as those provided on the housing of the power tool 100. A first and second biased latch 146a and 146b may be provided to clamp or latch onto clasp sections formed on the opposing surface of the handle end of the tool. A similar latch mechanism may be provided at the opposite end 112 of the extension pole. The latch mechanism 144 shown in FIGS. 10 and 11 has two pincers or biased latches 146a and 146b that attach to the housing 102. The latch mechanism 144 keeps the two ends 104, 106 of the housing 102 and extension pole together until the handle release button 122 is pressed. Once the handle release button 122 is pressed, the tool end 104 separates from the extension pole and similarly latches are provided to detach the handle end 106.

While shown herein, the exemplary embodiment power tool may be utilized as a chain saw. However, as described, the primary components of the power tool and the separable nature of the handle end and the power tool end of the tool with the ability to interconnect the two ends with an extension pole, may be utilized with many different implements and power tool features. Primarily, the design presented herein allows the trigger end and battery of the tool to be separated from the power head end and motor. Further, electrical connection may be maintained between the two ends with no extra parts as the extension pole described herein may be installed without the need for of external tools and maintains electrical and control between the two halves through the extension pole.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention

1. A power tool comprising:
a housing having a tool end and a handle end, said handle end having a battery and said tool end having a motor;
wiring in said handle end, wherein said wiring extends from said battery to a first connector in said handle end;
a second connector on said tool end that electrically connects to said first connector when said tool end and said handle end are removably mated together, said second connector in electrical connection with said motor; and
a latch mechanism that releasably attaches said tool end to said handle end.

2. The power tool of claim 1 further comprising a pole that can be releasably placed between said tool end and said handle end when said tool end and said handle end are separated, wherein said pole contains electrical wiring and connectors that connects said first connector to said second connector.

3. The power tool of claim 2 wherein said pole comprises a first end having a recess and a second end having a locking extension.

4. The power tool of claim 3 wherein said handle end comprises a recess into which said locking extension of said second end of said pole releasably fits.

5. The power tool of claim 3 wherein said tool end comprises a locking extension that fits into said recess of said first end of said pole.

6. The power tool of claim 1 wherein said tool end comprises a locking extension, said handle end has a recess into which said locking extension fits.

7. The power tool of claim 1 further comprising a handle release button on said handle end, said handle release button can be depressed to release said handle end from said tool end.

8. The power tool of claim 1 wherein said tool end has a saw implement.

9. The power tool of claim 1 wherein said tool end has a hedge trimming implement.

10. The power tool of claim 1 wherein said tool end has a gardening attachment.

11. The power tool of claim 1 wherein said pole is a telescoping pole.

12. An extendable power tool comprising:
a housing having a tool end and a handle end, said handle end having a battery and said tool end having a motor;
wiring in said handle end extending from said battery to a first connector in said handle end;
a second connector on said tool end that electrically connects to said first connector and that electrically connects to said motor; and
an extension pole that can be inserted between said tool end and said handle end when said tool end and said handle end are separated.

13. The extendable power tool of claim 12 further having a latch mechanism that joins said handle end to said tool end.

14. The extendable power tool of claim 12 further having a handle release button, wherein said handle release button can be depressed to release said handle end from said tool end.

15. The extendable power tool of claim 12, wherein said tool end has a cylindrical mounting extension.

16. The extendable power tool of claim 15, wherein said handle end comprises a recess into which said extension of said tool end releasably inserts.

17. An extendable chainsaw comprising:
a tool end having a chain saw removably attached to a handle end having a handle and a trigger mechanism;
a first electrical connector on said handle end;
a second electrical connector on said tool end;
wherein said second electrical connector of said tool end and said first electrical connector of said handle end electrically connect when said tool end is releasably connected to said handle end, said handle end having a battery pack powering a motor mounted on said tool end through said first and said second electrical connectors.

18. The extendable chainsaw of claim 17, further comprising an extension pole, wherein said pole can be releasably inserted between said tool end and said handle end, wherein said pole maintains electrical connectivity between said first electrical connector and said second electrical connector.

19. The extendable chainsaw of claim 18, wherein said pole is a telescoping pole.

20. The extendable chainsaw of claim 17 wherein said battery is electrically connected to said first electrical connector.

21. An expandable power tool comprising:
a power tool separable into a trigger end and an implement end, said trigger end having a user actuated trigger positioned thereon, said implement end having a motor, said motor and said trigger in electrical controlling connectivity;
a power supply at either of said trigger end or said implement end;
a mechanical retaining mechanism removably connecting said trigger end with said implement end, said retaining mechanism positioned on either said trigger end or said implement end and connecting to the other of said trigger end or implement end;
wherein said trigger on said trigger end electronically controls said motor and wherein said trigger end and said implement end are in electrically removable contact with each other.

22. The power tool of claim 21 wherein said implement end has said motor driving a chain.

23. The power tool of claim 21 wherein said mechanical retaining mechanism is a latch.

24. The power tool of claim 21 wherein said power supply is a battery affixed on said trigger end of said power tool.

25. The power tool of claim 21 further comprising an extension pole removably positioned between said trigger end and said implement end.

26. The power tool of claim 21 wherein said trigger end has a handle, said trigger and a battery and said mechanical retaining mechanism, said mechanical retaining mechanism being a handle release button, said implement end having said motor driving an power tool implement.
